(19) United States
(12) Patent Application Publication
(10) Pub. No.: US 2005/0047696 A1
(43) Pub. Date: Mar. 3, 2005

(54) Apparatus and method for retaining bearings

(76) Inventors: Dana M. Serrels, Davison, MI (US); Thomas W. Newman, Flint, MI (US); Mark D. Jones, Goodrich, MI (US)

Correspondence Address: JIMMY L. FUNKE, ESQ.;DELPHI TECHNOLOGIES, INC., P.O. Box 5052, Mail Code: 480-414-420, Troy, MI, 48007-5052, US

(21) Appl. No.: 10/650,939

(22) Filed: Aug. 28, 2003

(51) Int. Cl. F16C 43/00

(52) U.S. Cl. 384/537

(57) ABSTRACT

A bearing and bearing retaining structure, comprising: a bearing pocket defining a bearing opening for receiving the bearing therein, the bearing pocket having an outer wall defining a portion of the bearing pocket; and a retention feature for retaining the bearing in the bearing pocket, the retention feature being formed from a portion of the outer wall after the bearing is inserted in the bearing opening, wherein the retention feature is formed using a radial riveting process by applying a tool under force to an outer surface of the outer wall after the bearing is inserted into the bearing pocket.

### TECHNICAL FIELD

This application relates to a method and apparatus for retaining a bearing in a bearing housing.

### BACKGROUND

Numerous methods have been employed for retaining a bearing within a supporting structure. One method employs the use of multiple bearing stakes placed in discrete locations about the bearing circumference wherein the stakes are placed in spatial relationship with regard to each other and the bearing retention feature is then formed by displacing a portion of each of the plurality of stakes and positioning it about a portion of the circumference of the bearing, the reformed stake now retains the bearing in place. The material of the stake is displaced by a high force shearing process and tool. These multiple bearing stakes have limited support area and are susceptible to fracture due to their weakening by the high force forming process. Such high forces may reach and exceed 1,500 pounds. Also, other surrounding materials as well as the stakes are deformed and weakened by the application of these high forces thus; they are susceptible to failure at 4,000 to 6,000 Newtons (FIG. 5). In addition, the tooling associated with such a method requires sharpening.

Another method employs the use of bearing stakes wherein the stakes are placed about the entire periphery or circumference of the bearing. The stake material is then displaced using the same procedure as above however; a continuous displacement of material surrounds the entire periphery or circumference of the bearing. As with the previous method these multiple bearing stakes have limited support area and are susceptible to fracture due to their weakening by the high force forming process. In addition, the tooling associated with such a method requires sharpening.

These prior methods have also been shown to be inadequate for applications wherein the bearing experiences high g-level vibrations.

Accordingly, it is desirable to provide a method and apparatus for providing a retaining member of a bearing wherein the material used for the retaining member is formed from a process wherein the material is not weakened due to high forming stresses.

### SUMMARY

The above discussed and other drawbacks and deficiencies are overcome or alleviated by placing a bearing in a bearing pocket and advancing a radial riveting tool and machine in order to engage an outer material of the bearing pocket. The radial riveting action displaces the bearing pocket material around the entire diameter of the bearing resulting in significantly higher retention capabilities when compared to prior designs. Moreover, the radial riveting action is applied at a much lower force than prior methods wherein non-retaining materials of the retaining structure are not damaged or deformed by the forming process.

A bearing and bearing retaining structure, comprising: a bearing pocket defining a bearing opening for receiving the bearing therein, the bearing pocket having an outer wall defining a portion of the bearing pocket; the bearing retention feature being formed from a portion of the outer wall after the bearing is inserted in the bearing opening, wherein the bearing retention feature is formed using a radial riveting process by applying a tool under force to an outer surface of the outer wall after the bearing is inserted into the bearing pocket.

A method for forming a bearing retaining structure, comprising: providing a bearing pocket having an outer wall of a deformable material; inserting a bearing into a bearing pocket defined by the outer wall; forming a retaining member from the outer wall, the retaining member retaining the bearing in the bearing pocket, wherein the retaining member is formed by applying a tool to the outer wall after the bearing is inserted into the bearing pocket.

The above-described and other features and advantages of the present invention will be appreciated and understood by those skilled in the art from the following detailed description, drawings, and appended claims.

### BRIEF DESCRIPTION OF THE DRAWINGS

FIG. 1 is a view of a tool used in an exemplary embodiment of the present invention;

FIG. 2 is a cross sectional view of a bearing pocket prior to forming;

FIG. 3 is a cross sectional view of a bearing pocket after forming with the tool of FIG. 1;

FIG. 4 is an illustration of a “rosette pattern”; and

FIG. 5 is a graph of test results for motor bearing retentions (Force v. Distance) of a sample formed in accordance with an exemplary embodiment and samples formed using other non-radial riveting methods.

### DETAILED DESCRIPTION OF EXEMPLARY EMBODIMENTS

Disclosed herein is an apparatus and system for retaining a bearing in an aluminum detail or other equivalent material capable of being formed and providing a retaining feature for a bearing. An exemplary embodiment consists of placing the bearing in a bearing pocket and forming a portion of the bearing pocket over the bearing to form the retention member over the bearing.

In an exemplary embodiment, a radial riveting machine and complimentary tool are used to form the material of the bearing pocket over the bearing. The retention member is formed using a radial riveting method wherein the tool travels in a “rosette pattern” by a planetary gear device or other means for moving the tool in accordance with the rosette pattern. The tool is applied under low force conditions e.g., up to 60 psi and preferably 30-35 psi as compared to the forces required for forming prior retaining structures. Accordingly, little damage or distortions occurs to the non-retaining portions of the structure (e.g., the materials from which the retaining feature is not formed). Of course, the aforementioned forces and ranges are provided as examples of exemplary embodiments and it is understood that forces higher and lower than the aforementioned ranges are contemplated in accordance with the present invention. Accordingly, the present invention is not intended to be limited to the specific ranges.

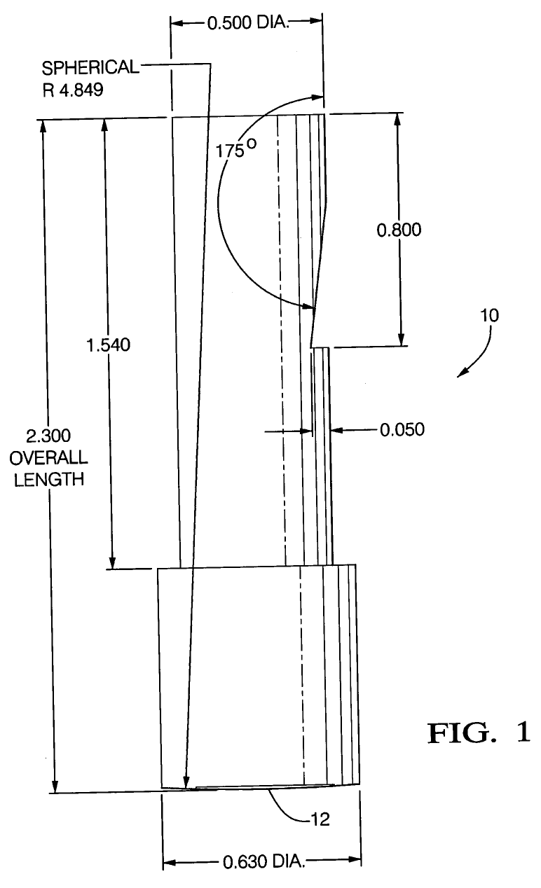

Referring now to FIG. 1, a tool 10 for use with a radial riveting machine (not shown) is illustrated. Tool 10 comprises a forward contact surface 12, which in an exemplary embodiment provides the contact surface for forming the bearing retention feature. Exemplary dimensions of tool 10 are provided in FIG. 1. Of course, it is contemplated that tool 10 may be configured to have other dimensions than those illustrated in FIG. 1. In an exemplary embodiment forward contact surface 12 has a spherical radius of 4.849 inches. Again, these dimensions are provided as an example of one embodiment and the present invention is not intended to be limited by the same.

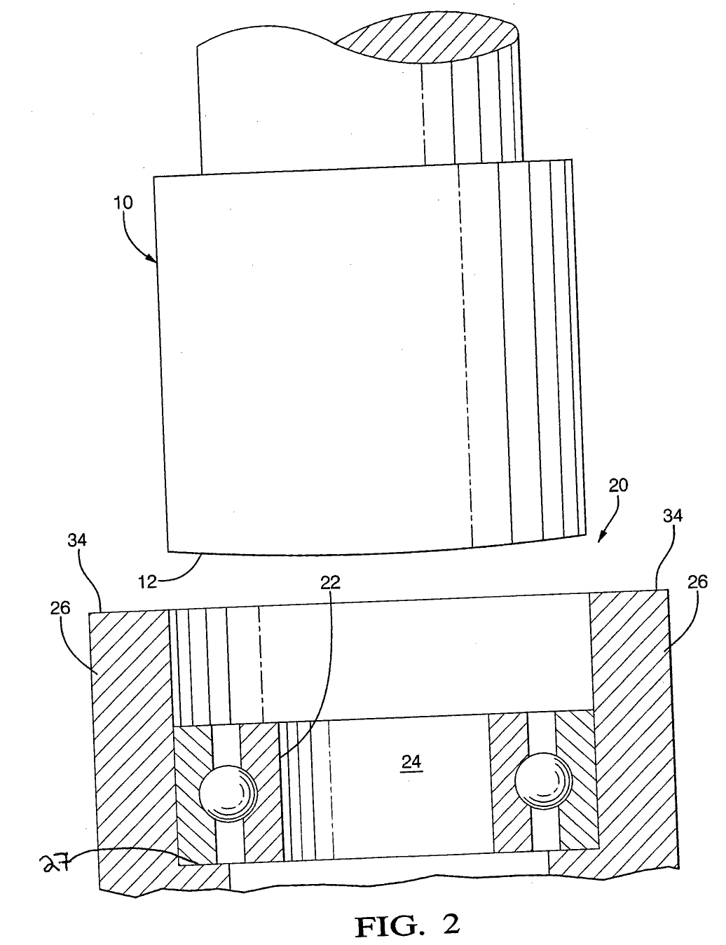

Referring now to FIG. 2, a bearing pocket 20 is illustrated prior to forming with tool 10. During the forming process a bearing 22 is inserted into an area 24 defined by an outer wall 26 of bearing pocket 20. In an exemplary embodiment bearing pocket 20 is formed by die casting and/or a machining process and is configured to have single unitary outer wall 26 which defines and surrounds the periphery of area 24. Of course, other equivalent manufacturing processes are understood to be within the scope of the present invention. In an exemplary embodiment outer wall 26 has a thickness defined by a range of approximately 2.5-4.0 mm with an exemplary thickness of approximately 3.5 mm. These values are larger than the thickness of the stakes used in prior retaining methods. It is also understood that these values are provided as examples and the thickness of wall 26 may be greater or less than the aforementioned ranges and values.

Also, and in accordance with an exemplary embodiment outer wall 26 is circular and is defined by an inner diameter which corresponds to an outer diameter of the outer race of the bearing (e.g., large enough to allow the bearing to be inserted therein or press fit therein (e.g., slight engagement or frictional fit between the outer wall and the bearing)). The inner diameter is in one embodiment based upon the axis of rotation of an inner race of the bearing or the center of an opening defined by the single shoulder 27 or wall of bearing pocket 20. Of course, other non-circular enclosures are considered to be within the scope of the present invention.

In another exemplary embodiment, the outer wall comprises a plurality of arcuate portions with gaps disposed therebetween wherein the arcuate portions are each defined by an inner diameter which corresponds to an outer diameter of the outer race of the bearing (e.g., large enough to allow the bearing to be inserted therein or press fit therein (e.g., slight engagement or frictional fit between the outer wall and the bearing)). In this embodiment, the arcuate portions may extend from the shoulder supporting the bearing wherein the gaps between the arcuate portions are defined partially by the shoulder portion or alternatively the arcuate portions extend from a wall which depends from the shoulder portion, in this alternative the wall may extend partially alongside the outer race of the bearing or past the height of the outer race of the bearing and the arcuate portions will extend therefrom.

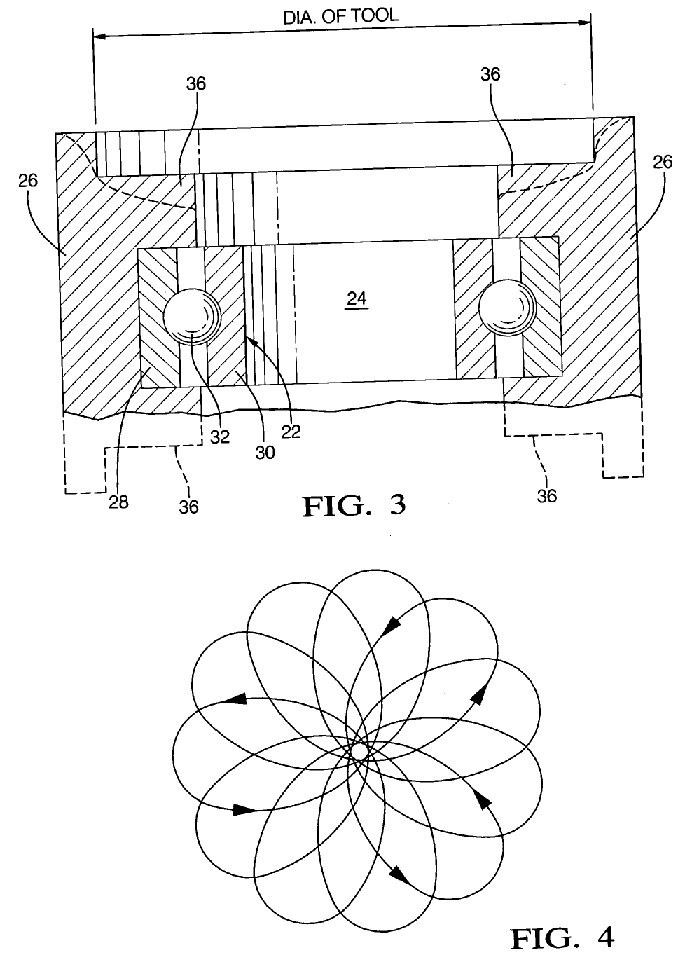

In an exemplary embodiment, bearing pocket 20 comprises a single step or shoulder 27 for receiving bearing in the bearing pocket while outer wall 26 extends therefrom such that a portion of the shoulder protrudes away from the wall to support the bearing. As illustrated bearing 22 has an outer ring member or outer race 28 and an inner ring member or inner race 30 and a plurality of ball bearings 32. In accordance with an exemplary embodiment outer wall 26 is configured to surround or match the outer periphery of bearing 22. In addition, outer wall 26 is made out of a deformable material such as aluminum or equivalents thereof, which is capable of being deformed without adversely affecting the material strength. It is, of course, understood that the bearing pocket and bearing illustrated in FIGS. 2 and 3 are examples of possible configurations and the bearing and bearing pocket may have alternative configurations than those illustrated herein.

In accordance with an exemplary embodiment a portion of outer wall 26 extends higher than the profile of the bearing and will comprise a retention member of bearing 22 after the forming process. During the forming process a top portion 34 of outer wall 26 is contacted under pressure by contact surface 12 of tool 10. The tool is passed over top portion or surface 34 in an engaging fashion under applied pressure and in a rosette pattern (illustrated in FIG. 4). This process is performed using a radial riveting machine, which is known to those skilled in the related arts. Due to the radial configuration of forward contact surface 12 and the pressure applied by a radial riveting machine (not shown), and the rosette pattern, the tool will deform a portion of outer wall 26 on each successive pass until a predetermined depth and/or portion of material has been dislodged or formed over a portion of bearing 22.

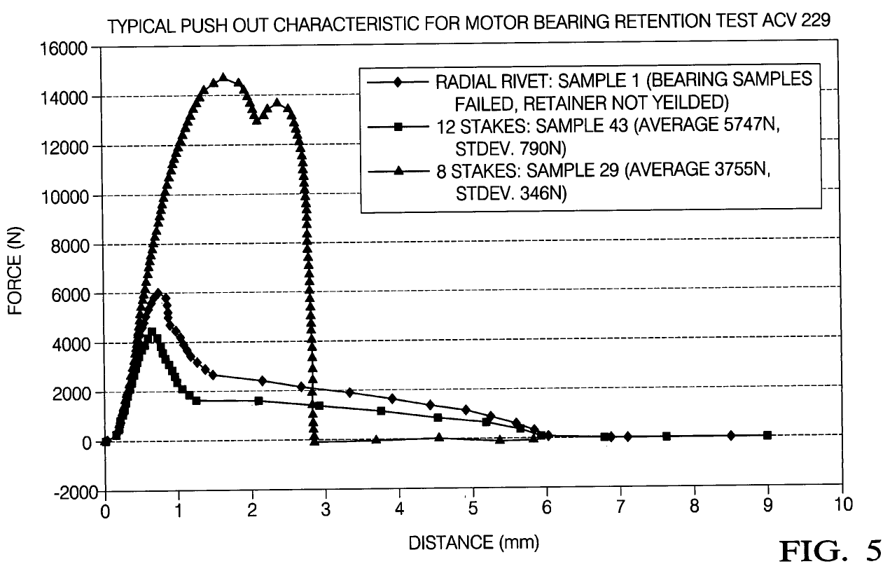

The amount of applied force, time and tool shape will dictate the capability of the radial forming of the retention feature. By modifying the force and time, the amount of material displaced can either be increased or decreased in thickness and the diameter of the overlapping material of the retention member can be varied accordingly. As discussed above the amount of required force is low force or significantly less than the prior forming methods thus, unwanted deformation or weakness of the bearing structure does not occur. This results in a bearing retaining structure having improved performance over the retaining structures formed in accordance with prior methods, see for example the empirical results in FIG. 5.

Referring now to FIG. 3 bearing pocket 20 is illustrated after forming with tool 10. As illustrated, the portion of dislodged material is now positioned to define a retention member or feature 36, which will hold bearing 22 in place. Retention member 36 is formed so that it makes contact with outer bearing race 28 while still allowing inner bearing race 30 to move with respect to outer bearing race 28 in order to provide the desired performance.

Accordingly, a bearing retention feature is provided from outer wall 26 wherein the displaced portion is formed from a portion of outer wall 26 which is positioned above bearing 22. Thus, a minimal portion of outer wall 26, which is adjacent to bearing 22 is deformed by tool 10. Therefore, unnecessary stresses are not applied to this portion during the forming process. Although FIG. 3 illustrates a portion of outer wall being unmodified to provide the retention feature it is understood that the entire portion of outer wall 26 above bearing 22 may be deformed to provide the retention feature. Furthermore, the final configuration of retention feature may be modified according to the shape of the forward contact edge of the tool being used by the forming process in addition to varying the force applied and time of each pass of forming tool 10 on wall 26. An example of one possible alternative configuration of retention feature 36 is illustrated by the dashed lines in FIG. 3.

In accordance with an exemplary embodiment, the method allows material of outer wall 26 to overlap the entire circumference of bearing 22. Accordingly, a bearing retention feature is provided with full circumferential support with no damage to the base material from which the retaining feature is formed. Alternatively, and if arcuate wall portions are used the bearing retention feature will make intermittent contact with the outer circumference of bearing 22.

Moreover, since the forward contact surface of the tool does not require a sharp edge to perform the forming process the maintenance of the tool is reduced, as there is no requirement for sharpening. Also, since a blade is not applied to outer wall 26 less stress is applied to the material being deformed.

It is understood that the position of tool 10 in FIG. 2 may vary angularly with respect to the outer wall 26 and the tool may be applied in other patterns than those illustrated in FIG. 4. Also, the applied forces may vary to provide the desired movement upon each pass while not adversely affecting the tensile strength of the material being deformed.

In yet another alternative, the opposite side of outer wall 26 may be deformed to provide an alternative or another retention feature 36 illustrated by the dashed lines of FIG. 3, of course, this other retention feature would be formed before or after the forming of the other retention feature.

Referring now to FIG. 5, empirical results are provided wherein test results for motor bearing retentions (Force v. Distance) of a sample formed in accordance with an exemplary embodiment are compared to those formed using other non-radial riveting methods. More particularly, the radial riveted bearing is compared to 8 staked bearings and 12 staked bearings, which are formed by use of multiple bearing stakes placed in discrete locations about the bearing circumference wherein the stakes are placed in spatial relationship with regard to each other and then the bearing retention feature is formed by removing a portion of each of the plurality of stakes and positioning it about a portion of the circumference of the bearing, wherein the reformed stake now retains the bearing in place.

Clearly, the results show greater retention strength of the retainer formed by the process of exemplary embodiments of the present invention. In fact, the testing results indicated that the load capability of the bearing tested was exceeded before failure of the retention feature was obtained.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It should also be noted that the terms “first”, “second”, and “third” and the like may be used herein to modify elements performing similar and/or analogous functions. These modifiers do not imply a spatial, sequential, or hierarchical order to the modified elements unless specifically stated.

1. A bearing and bearing retaining structure, comprising:
a bearing pocket defining a bearing opening for receiving the bearing therein, said bearing pocket having a single shoulder for supporting the bearing and a unitary outer wall extending therefrom, said unitary outer wall defining a portion of said bearing pocket, said unitary outer wall being defined by a uniform inner diameter corresponding to an outer diameter of the bearing; and
a retention feature for retaining the bearing in said bearing pocket, said retention feature being formed from a portion of said outer wall after the bearing is inserted in said bearing opening, wherein said retention feature is formed using a radial riveting process by applying a tool under force to an outer surface of said outer wall after the bearing is inserted into said bearing pocket.

2. The bearing and bearing retaining structure as in claim 1, wherein the portion of said unitary outer wall from which said portion is formed extends past the bearing when the bearing is inserted in said bearing opening and the portion comprises an end portion of said unitary wall.

3. The bearing and bearing retaining structure as in claim 2, wherein only a portion of the portion of said unitary outer wall from which said portion is formed is used to retain the bearing.

4. The bearing and bearing retaining structure as in claim 1, wherein said outer wall is formed from aluminum.

5. The bearing and bearing retaining structure as in claim 1, wherein said unitary outer wall is circular in shape and completely surrounds the periphery of the bearing when the bearing is inserted within an area defined by said unitary outer wall.

6. The bearing and bearing retaining structure as in claim 1, wherein said retention feature makes contact with an entire periphery of an outer race of the bearing.

7. The bearing and bearing retaining structure as in claim 1, wherein said retention feature comprises a pair of retention features each being formed from said outer wall and one of said pair of retention features each being positioned on one side of the bearing and the other one of said pair of retention features being positioned on another side of said bearing.

8. A method for forming a bearing retaining structure for retaining a bearing therein, comprising:
providing a bearing pocket having a single shoulder for supporting an outer race of the bearing and a unitary outer wall extending therefrom, said unitary outer wall being formed of deformable material and having a uniform inner diameter corresponding to an outer diameter of the bearing;
inserting the bearing into a bearing pocket defined by said unitary outer wall and said single shoulder;
forming a retaining member from said unitary outer wall, said retaining member retaining said bearing in said bearing pocket, wherein said retaining member is formed by a radial riveting process by applying a tool to said outer wall after said bearing is inserted into said bearing pocket.

9. The method as in claim 8, wherein said tool is applied to said unitary outer wall by a radial riveting machine, said radial riveting machine applies a force to said tool for forming said retaining member.

10. The method as in claim 8, wherein said tool has a forward contact edge for making contact with an end portion of said unitary outer wall which extends past the bearing, said forward contact edge having a convex shape.

11. The method as in claim 10, wherein said tool follows a rosette pattern during the formation of said retaining member.

12. The method as in claim 8, wherein retaining member is a retention feature formed by said tool following a rosette pattern.

13. The method as in claim 12, wherein said retention feature makes contact with an entire periphery of an outer ring member of said bearing.

14. The method as in claim 13, wherein said retention feature is formed from a deformable material.

15. The method as in claim 14, wherein said deformable material is aluminum and said tool is applied to said unitary outer wall by a force in a range defined by 25 to 65 psi.

16. A bearing and bearing retaining structure, comprising:
a bearing pocket defining a bearing opening for receiving the bearing therein, said bearing pocket having a single shoulder for supporting the bearing and a unitary outer wall extending therefrom, said unitary outer wall having a uniform inner diameter corresponding to an outer diameter of the bearing, said unitary outer wall defining a portion of said bearing pocket; and
a retaining member for retaining the bearing in said bearing pocket, said retaining member being formed from a portion of said unitary outer wall after the bearing is inserted in said bearing opening, wherein said retaining member is formed using a radial riveting process by applying a tool under force to an outer surface of said wall after the bearing is inserted into said bearing pocket.

17. A bearing and bearing retaining structure as in claim 16, wherein said retaining member is a retention feature making contact with an entire periphery of outer race of the bearing.

18. A bearing and bearing retaining structure as in claim 16, wherein said retaining member is formed from a portion of said unitary outer wall which extends past the bearing when the bearing is inserted in said bearing opening.

19. A bearing and bearing retaining structure as in claim 18, wherein said retaining member makes contact with an entire periphery of a portion of the bearing.

20. The bearing and bearing retaining structure as in claim 1, wherein said unitary outer wall comprises a plurality of arcuate shaped members each being defined by an inner diameter wherein said inner diameter corresponds to an outer diameter of the bearing.
